(19) United States
(12) Patent Application Publication
(10) Pub. No.: US 2025/0035083 A1
(43) Pub. Date: Jan. 30, 2025

(54) WIND TURBINE WITH BLADES INCLUDING OPENINGS FOR CONTROLLING ROTATIONAL SPEED

(71) Applicant: INTERNATIONAL BUSINESS MACHINES CORPORATION, ARMONK, NY (US)

(72) Inventors: Jagabondhu Hazra, Bangalore (IN); Sarbajit K. Rakshit, Kolkata (IN); Manikandan Padmanaban, Chennai (IN)

(21) Appl. No.: 18/358,482

(22) Filed: Jul. 25, 2023

(51) Int. Cl. F03D 1/06; F03D 7/02; F03D 17/00

(52) U.S. Cl. CPC F03D 1/06495; F03D 1/0648; F03D 7/0236; F03D 7/0252; F03D 17/028; F05B 2270/1011; F05B 2270/17

(57) ABSTRACT

A wind turbine that includes a plurality of turbine blades. Each of the plurality of turbine blades includes a plurality of openings that extend through each of the plurality of turbine blades, the plurality of openings are adapted to be opened or closed, and at least one of the plurality of openings is adapted to be opened to allow air to flow therethrough.

### BACKGROUND

The present disclosure relates to wind turbines. More particularly, the present disclosure provides a wind turbine with blades including openings for controlling rotational speed.

Human civilization has harnessed wind power for thousands of years. Early forms of windmills used wind to crush grain or pump water. Now, modern wind turbines use wind to create electricity.

### SUMMARY

According to some embodiments of the disclosure, there is provided a wind turbine. The wind turbine includes a plurality of turbine blades. Each of the plurality of turbine blades includes a plurality of openings that extend through each of the plurality of turbine blades, the plurality of openings are adapted to be opened or closed, and at least one of the plurality of openings is adapted to be opened to allow air to flow therethrough.

According to some embodiments of the disclosure, there is provided a method. The method includes an operation of providing a wind turbine including a plurality of turbine blades, wherein each of the plurality of turbine blades includes a plurality of openings that extend through each of the plurality of turbine blades, the plurality of openings are adapted to be opened or closed, and the plurality of openings are adapted to be opened to allow air to flow through the plurality of turbine blades. Another operation is performing a stress analysis on the plurality of turbine blades using parameters of the wind turbine and a wind profile. A further operation is controlling the plurality of openings to open one or more of the plurality of openings based on the stress analysis.

According to some embodiments of the disclosure, there is provided a system. The system includes a wind turbine including a plurality of turbine blades, wherein each of the plurality of turbine blades includes a plurality of openings that extend through each of the plurality of turbine blades, the plurality of openings are adapted to be opened or closed, and at least one of the plurality of openings is adapted to be opened to allow air to flow therethrough. The wind turbine also includes a control system with a control unit connected with at least one activating mechanism such that the control unit activates the at least one activating mechanism to open or close the plurality of openings.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an example graph of power versus wind velocity for a turbine, in accordance with embodiments of the disclosure.

FIG. 2 illustrates a wind turbine, in accordance with embodiments of the disclosure.

FIG. 3A illustrates a turbine blade, in a closed configuration, in accordance with embodiments of the disclosure.

FIG. 3B illustrates the turbine blade of FIG. 3A, in an open configuration, in accordance with embodiments of the disclosure.

FIG. 4 illustrates a flow chart of a system architecture for a wind turbine, in accordance with embodiments of the disclosure.

FIG. 5 is a flow diagram of a method of controlling a rotational speed of a wind turbine, in accordance with embodiments of the disclosure.

FIG. 6 is a block diagram view of a system, in accordance with embodiments of the disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate generally to wind turbines. More particularly, the present disclosure provides a wind turbine with blades including openings for controlling rotational speed. While the present disclosure is not necessarily limited to such applications, various aspects of the disclosure can be appreciated through a discussion of various examples using this context.

Wind in motion contains energy that can be converted into electrical energy via wind turbines. The wind transfers power to the turbine and loses speed while doing so. The power output of a turbine (P) is calculated using the following equation:

P=½*(air density)*(wind speed3)*(rotor swept area)*(power coefficient) (1)

Air density can vary with temperature and altitude, but generally can be about 1.225 kg/m³. Wind speed is how fast the wind moves. Since the wind speed is cubed in the equation, a small difference in wind speed can make a large difference in power output. Rotor swept area is how large of an area that a turbine blade sweeps during rotation. The larger the turbine blades, the bigger the rotor swept area and the more power that can be captured. The rotor swept area is given by π*r². The power coefficient is an indicator about how effective the turbine is at extracting power from the wind. The power coefficient varies with both blade pitch angle and tip speed rotation. The blade pitch angle is based on how the blades of the turbine are pitched, or angled, in order to capture more or less energy. The tip speed ratio is a measure of how fast the tips of the turbines move in relation to the air around the turbines.

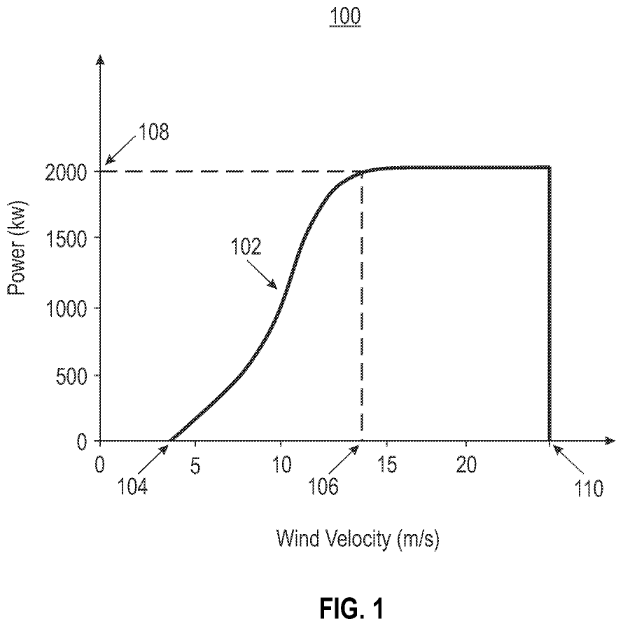

FIG. 1 illustrates an example graph 100 of power (in kilowatts (kW)) versus wind velocity (in meters per second (m/s)) for an example turbine, in accordance with embodiments of the disclosure. A line 102 in the graph represents an example of power versus wind velocity for a turbine. The line 102 begins to increase beyond a zero (0) value of wind velocity at a point called a cut-in speed 104. The cut-in speed 104 is a speed, or velocity, where the turbine will start to rotate. As the wind velocity increases, the power also increases, as shown. The line 102 levels off at a certain wind velocity known as the “rated velocity” 106 and at a power known as the “rated power” 108. As a certain wind speed or velocity is reached, the turbine includes a cut-out speed 110 (otherwise known as “cut-off speed”) at which the turbine is stopped. The cut-out speed is the wind speed where the wind is so powerful that it is no longer deemed safe for the turbine to operate under strain that the wind puts on the turbine.

A particular turbine's cut-in and cut-out speeds are determined by a manufacturer, and can be complied with in order to protect the turbine from damage. The cut-in speed is the point at which the turbine starts generating electricity from turning. The cut-in speed (typically between 6 and 9 mph) is when the blades start rotating and generating power. As wind speeds increase, more electricity is generated until it reaches a limit, known as the rated velocity. The cut-out speed is more important though, and denotes how fast the turbine can go before wind speeds get so fast that it risks damage from further operation. When an anemometer registers wind speeds higher than fifty-five (55) miles per hour (mph), for example, (cut-out speed varies by turbine), it can trigger the wind turbine to automatically shut off. Alternatively, the turbine can feather its blades, for example, meaning that the blades can be turned to be parallel with the air and no longer capture any wind power. Wind blade angle can be changed to align with wind direction by using pitch control. However, pitch angle does have a limitation, such as to only be able to rotate the blades in the range of about −25 or +25 degrees.

Wind speeds vary by terrain. For example, wind speeds are likely to be significantly higher along a coastal area than further inland, and wind also moves faster on hills. Most of the time, in such coastal hilly areas, wind speed can be high, so it can be required to apply a brake on wind turbines. The primary safety issue with wind turbines comes from over-speeding. Some sort of stall or brake mechanism can be used in the wind turbines in order to shut down the turbine before it reaches a danger zone. A wind turbine with a brake mechanism can be referred to as “stall-controlled.”

Wind turbines across the globe are failing at an alarming rate due to damage caused by over-speeding without the use of brakes or stopping mechanisms. Therefore, a need exists to be able to reduce damage or thrust force on wind turbines. However, the ability to reduce damage, while still allowing the wind turbine to operate and generate power beyond the cut-out speed, is desired.

Embodiments of the present disclosure relate to a wind turbine. The wind turbine includes a plurality of turbine blades. Each of the plurality of turbine blades can include a plurality of openings that extend through each of the plurality of turbine blades. The plurality of openings are adapted to be opened or closed, and at least one of the plurality of openings is adapted to be opened to allow air to flow therethrough. The plurality of openings are adapted to be opened when the wind turbine nears or reaches a cut-out speed of the wind turbine in order to avoid damage to the wind turbine from wind speeds above the cut-out speed.

For purposes of this disclosure, reference will be made to an illustrative wind turbine system that can utilize perforated holes on blades of a turbine in order to function over cut-out speed for the turbine. Of course, the disclosure herein should not be considered to be limited to the illustrative examples depicted and described herein. With reference to the attached figures, various illustrative embodiments of the devices, systems and methods disclosed herein will now be described in more detail.

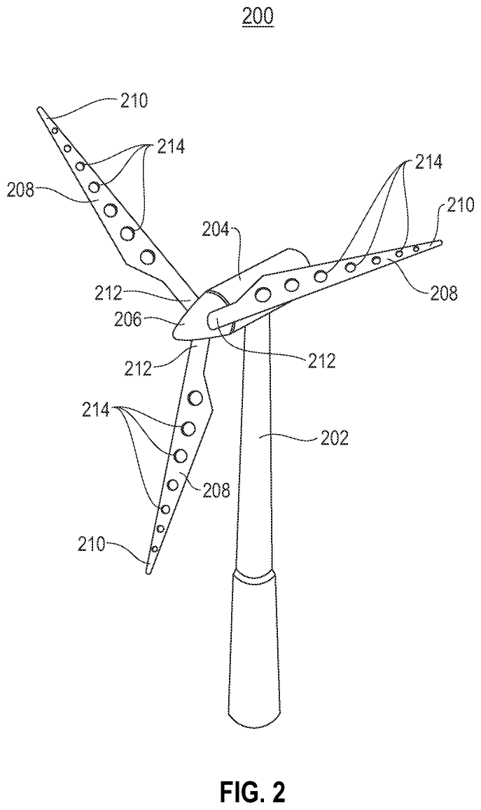

FIG. 2 illustrates a wind turbine 200 with a tower 202, a nacelle 204 and a rotor including a hub 206 and three (3) blades 208 extending therefrom, in accordance with embodiments of the disclosure. The nacelle 204 houses a drive train to which an electric generator can be connected (not shown). The hub 206 bears the 3 blades 208 at a lateral end of the nacelle 204. Each of the blades 208 includes a blade tip 210 and a blade root 212. The blades 208 can be provided with perforated holes 214 that can be opened and closed by activation of an activating mechanism. At high wind speeds, at least some of (or all of) the perforated holes 214 can be in an open position (as shown). As a result, at high wind speeds, or beyond the cut-out speed, the blade 208 wind can pass through the perforated holes 214, which will reduce force on the wind turbine 200 and rotational speed. However, the blades 208 can still rotate at a lower speed (below cut-out speed) in order to still generate some electricity.

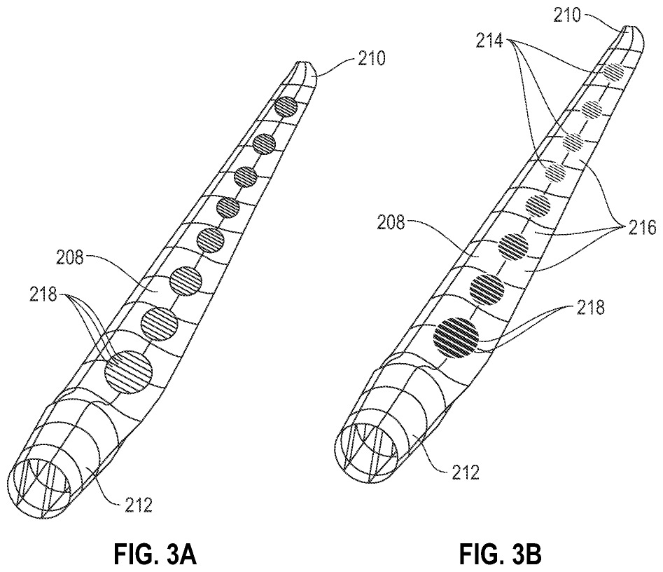

FIG. 3A illustrates a turbine blade 208, in a closed configuration, and FIG. 3B illustrates the turbine blade 208 of FIG. 3A, in an open configuration, in accordance with embodiments of the disclosure. The turbine blade 208 includes a plurality of perforated holes 214 or openings that can be opened and closed. The perforated holes 214 can be closed when the wind speed is within, or less than, the cut-out speed. The perforated holes 214 can be opened when the wind speed is beyond the cut-out speed. The wind can then pass through the perforated holes 214 and will not be able to apply force on the whole blade surface. With the perforated holes 214 open, the wind can still apply force on non-perforated areas 216 of the blade 208. As shown, one example of a mechanism for opening and closing the perforated holes 214 is to include shutters 218 that can be actuated in order to open and close the openings in the blade 208. The shutters include a plurality of louvers that are arranged parallel and capable of being opened and closed to different extents, such as partially or completely. Therefore, the wind turbine including the blades 208 shown in the open configuration can still rotate and produce some power, although the rotation and power produced will be lowered (compared to when the perforated holes 214 are closed) so as to not exceed a danger zone (above the cut-out speed) for the wind turbine.

Any suitable feature can be included in the blades 208 in order to open and close the perforated holes 214. For example, the perforated holes 214 can include shutters 218 that are capable of opening and closing. Other examples of features that can be used to open and close the perforated holes 214 include, but are not limited to, camera shutter-type features, sliding features, and/or hydraulic or pneumatic feature-based shutter mechanisms, etc. Other suitable features are also contemplated in order to open and close the perforated holes 214.

The perforated holes 214 can be adjustable (i.e., opened, closed, or partially opened) by means of one or more activating mechanisms or devices to allow air to either flow through portions of the wind turbine blades 208 or not. The activating mechanism can use shutters to control an opening area of the perforated holes 214 such that, at any point in time, air flow rate can be controlled through the wind turbine blades 208. The activating mechanism can, for instance, be driven by hydraulics, electromagnetism, pneumatics or piezoelectric fibers. Other suitable activating mechanisms are contemplated by the disclosure.

The wind turbine blades 208 can include a control system (not shown) with a control unit (not shown) communicating with the activating mechanism and load and/or wind speed sensors such that the control unit can activate the activating mechanism and thus adjust the perforated holes 208 in accordance with the measurements made by the load and/or wind sensors, for example. Such a wind turbine blade 208 can thus be “automatically controlled” in that it per se adapts its rotor speed according to load and/or wind speed and thus can require no external control.

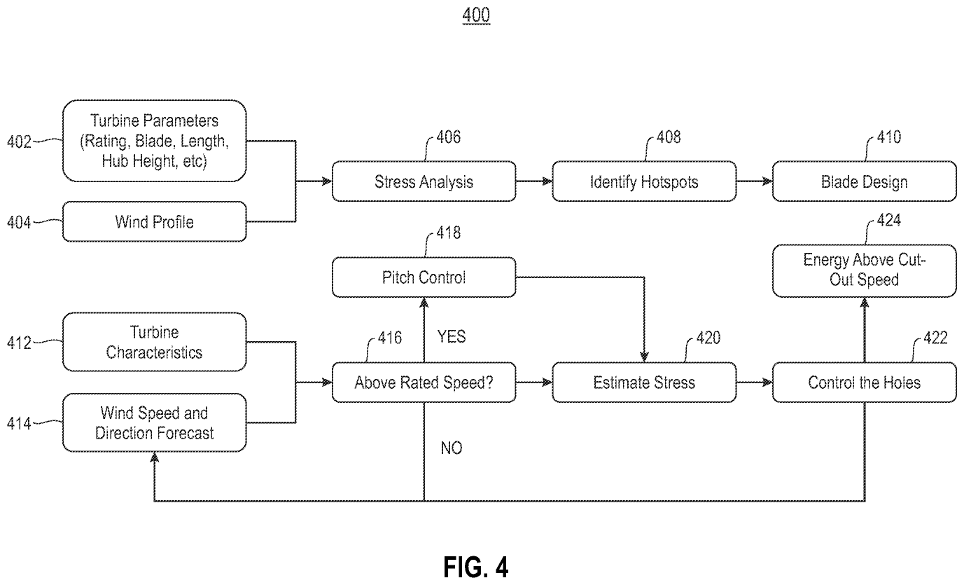

FIG. 4 illustrates a flow chart of a system architecture 400 for a wind turbine or a plurality of wind turbines, in accordance with embodiments of the disclosure. The flow chart of the system architecture 400 can include a block 402 of a determination or consideration of turbine parameters, such as a rating of the turbine, a blade length of blades in the turbine, a hub height of the turbine, etc. Other suitable parameters of the turbine can be considered, and are not limited to those listed herein. A block 404 includes consideration of a wind profile for wind that is moving through the turbine at any given time in any given area. The information collected at both of the blocks 402, 404 can be used regarding a block 406, which includes stress analysis on the turbine and turbine blades. Any computer program or computing device (not shown) can be used to perform the stress analysis and can be termed a “stress analyzer.” A block 408 includes identification of hotspots on the turbine blades, for example. Such “hotspots” can be determined to be areas where the blade can experience stress that can result in potential damage to the blade, for example. Load sensors, for example, can be located in various locations on the blades and can identify such hotspots. A block 410 is a blade design that can address potential stress on the blades and possible hotspots. The blade design can include opening or closing perforated holes at hotspots, for example, such as 214 in FIGS. 3B, as necessary to avoid damage to the turbine blades given certain wind speeds.

The system architecture 400 also includes features that allow for changing the turbine blade design during operation of the turbines, in response to changes in wind speed, etc. The block 410 can feed into a block 412. At the block 412, characteristics of the turbine are taken into consideration. Some examples of turbine characteristics include, for example, a speed rating for the turbine, blade length, hub height, etc. At block 414, a forecast of wind speed and wind direction are taken into consideration. The information from both blocks 412 and 414 lead to block 416 that includes a query as to whether the speed of the turbine blades is above the rated speed for the turbine. If the answer to the query is “no,” then the flow chart indicates that the system returns back to block 414. If the answer to the query in block 416 is “yes,” then pitch control of the turbine blades is taken into consideration at block 418. After block 418, at block 420, stress on the turbine blades is estimated. In accordance with the indication of stress on the turbine blades at certain locations, for example, the perforated holes or openings can be left open or closed, which is indicated by block 422. Controlling the perforated holes or openings can continue while the rotational speed is measured above a cut-out speed for the turbine, as indicated by block 424. If the rotational speed is below the cut-out speed, the system can return to block 414, as indicated. If the rotational speed continues to be above the cut-out speed, the turbine blades can be stopped in order to avoid damage to the turbine.

An optimization calculation can be used regarding design of a turbine blade, such as 208, that is installed with shutters (such as 218) in perforated holes (such as 214). A shutter area to be opened regarding each shutter (or regarding a total area of all shutters to be opened) can be selected such that an overall energy generation during high wind speed is maximized and shear stress on the blades is minimized. The optimization equation is:

$$J = Max \cdot {\sum }_{j = 1}^{N} {u}_{j} \{ {w}_{s} \cdot {E}_{s , j} - {w}_{stress} \cdot {T}_{stress , j} \} \qquad ( 2 )$$

where J is a cost function, uⱼ is a binary decision variable (whether a shutter j is selected to operate), E_{s,j} is an increase in power generation during shutter operation at pixel j, T_{stress,j} is shear stress at shutter j, Tₘᵢₙ, Tₘₐₓ are minimum and maximum stress, and wₛ, wₛₜᵣₑₛₛ is a weighing coefficient for additional generation by opening shutters and the shear stress, respectively. The equation is subject to the following: T^{min}≤Tₛₜᵣₑₛₛ≤T^{max}. Shear stress can vary at different positions or locations on the turbine blade.

When wind is flowing around any wind power plant, then wind is applying forces on the surface of wind turbine blades. Based on the applied force, a lift force can be created on the blades of the wind turbine and the wind turbine can start rotating. The applied magnitude of the lift force on the surface of the wind turbine blade causes the wind turbine to start rotating and generating power. The magnitude of forces on the wind turbine blades depends on wind speed, and on the surface area of the wind turbine blades. On wind turbines, the dimension and surface area for any wind turbine blade can be fixed, so the force applied on the wind turbine blades then depends on wind speed.

According to embodiments of the disclosure, if wind speed around a wind turbine is increasing, then a surface area of the wind turbine blade can be gradually reduced by opening perforated holes in wind turbine blades. When the perforated holes are opened, force applied by the wind on the wind turbine blades can be reduced, such that a rotating speed of the wind turbine can also be reduced.

According to embodiments of the disclosure, on blades of a wind turbine, there can be an array of slidable elements located in chambers that can open and close perforated holes that extend through the blades. The blades can include multiple perforated holes that can be programmatically controlled.

According to embodiments of the disclosure, a number, sizes of and positions of perforated holes on each wind turbine blade can be set as desired. The opening and closing of the perforated holes can be dynamically controlled. The parameters of the perforated holes can be controlled such that only a desired amount of force from wind can be applied on the wind turbine blade at different levels of wind speed.

According to embodiments of the disclosure, perforated holes in wind turbine blades can include programmatically controlled shutters, or other activating mechanisms, which can be opened and closed. Opening and closing of the shutters, for example, can be controlled in order to open one or multiple perforated holes at any given time based on wind speed around the blade. Also, the amount that the shutters are opened can be controlled depending on wind speed around the blade.

According to embodiments of the disclosure, based on tracking or predicting wind speed in an area surrounding a wind turbine, one or more perforated holes in the wind turbine blades can be opened or closed. The wind can pass through the open perforated holes on the wind turbine, which can cause wind to flow through at least a portion of the wind turbine blade without creating too much force on the wind turbine blade so as to cause rotation or an increase in rotation speed beyond a cut-out speed. As the wind passes through open perforated holes on the wind turbine blade, force on the wind turbine blades can be reduced. The rotating speed of the wind turbine blade can be reduced, which can enable the wind turbine to generate power beyond cut-out speed and not be placed in stall-out mode.

According to embodiments of the disclosure, based on wind speed, a number of perforated holes in blades of a wind turbine that are enabled or disabled, their relative positions are controlled, and a level or amount of opening or closing can be controlled. The parameters of the perforated holes can be controlled when wind speed is beyond cut-out speed of the wind turbine. Even above cut-out speed, rotational speed of the wind turbine blade can be controlled, which can allow power generation at higher wind speeds,

According to embodiments of the disclosure, an estimation of energy generation potential beyond a cut-out speed can be calculated and associated shear stress can be estimated in order to programmatically control opening and closing of perforated holes on the wind turbine blades (using shutters, for example). Power generation can be maximized beyond the cut-out speed while maintaining the shear stress within an acceptable limit. In other words, the cut-out speed of a turbine can be increased by including and controlling the perforated holes in the blades, as described herein.

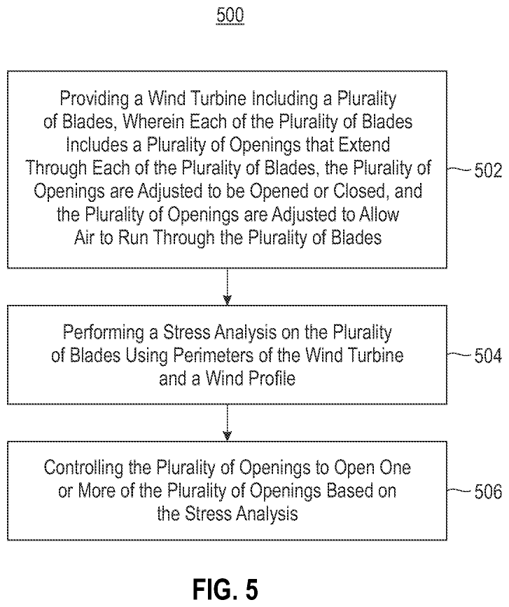

FIG. 5 is a flow chart of a method 500 of controlling a rotational speed of a wind turbine, in accordance with embodiments of the disclosure. The method 500 includes an operation 502 of providing a wind turbine (for example, 200 in FIG. 2) including a plurality of blades 208, wherein each of the plurality of blades 208 includes a plurality of perforated holes (or openings) 214 that extend through each of the plurality of blades 208, the plurality of holes 214 are adapted to be opened or closed, and the plurality of holes 214 are adapted to be opened to allow air to flow through the plurality of blades 208. The method 500 further includes an operation 504 of performing a stress analysis on the plurality of blades 208 using parameters of the wind turbine 200 and a wind profile. The method 500 further includes an operation 506 of controlling the plurality of holes 214 to open one or more of the plurality of holes 214 based on the stress analysis.

The method 500 can also include an operation of measuring a rotational speed of the wind turbine 200. In addition, the method 500 can include an operation of opening at least one of the plurality of holes 214 to allow air to flow therethrough when the rotational speed nears or reaches a cut-out speed of the wind turbine 200.

At least one embodiment includes a system which uses the combination of wind turbine parameters (rating, blade length, hub height, etc.,) and wind speed profile to perform shear stress analysis to identify the hotspots for designing blades of a wind turbine with shutters/perforated holes. The system can leverage a characteristic profile of the wind turbine and a wind speed profile to dynamically control an amount of opening and closing of the shutters/perforated holes in the blades to operate the wind turbine at speed higher than a cut-out speed for maximum power generation.

At least one embodiment includes a method proposed to dynamically control opening and closing of shutters/perforated holes through blades of a wind turbine considering a tradeoff between additional energy generation and acceptable shear stress on the blades. Opening of shutters/perforated holes can be controlled to bypass excess wind through the shutters/perforated holes in order to diffuse excess stress/thrust level along the blades beyond a cut-out speed of the wind turbine.

For purposes of description herein, the terms “upper,” “lower,” “top,” “bottom,” “left,” “right,” “rear,” “front,” “vertical,” “horizontal,” and derivatives thereof shall relate to the devices as oriented in the figures. However, it is to be understood that the devices can assume various alternative orientations and step sequences, except where expressly specified to the contrary. It is also to be understood that the specific devices and processes illustrated in the attached drawings, and described in the following disclosure, are simply exemplary embodiments of the inventive concepts defined in the appended claims. Hence, other physical characteristics relating to the embodiments disclosed herein are not to be considered as limiting, unless the claims expressly state otherwise.

For purposes of this description, certain aspects, advantages, and novel features of the embodiments of this disclosure are described herein. The disclosed processes, and systems should not be construed as being limiting in any way. Instead, the present disclosure is directed toward all novel and nonobvious features and aspects of the various disclosed embodiments, alone and in various combinations and sub-combinations with one another. The processes, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed processes can be used in conjunction with other processes. Additionally, the description sometimes uses terms like “provide” or “achieve” to describe the disclosed processes. These terms are high-level abstractions of the actual operations that are performed. The actual operations that correspond to these terms can vary depending on the particular implementation and are readily discernible by one of ordinary skill in the art.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

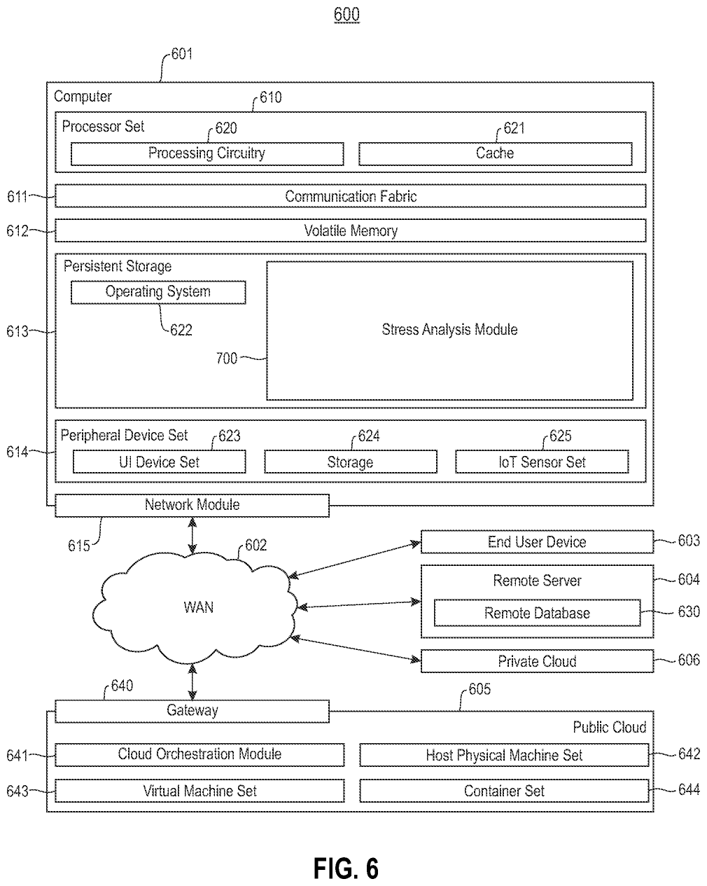

As in FIG. 6, computing environment 600 contains an example of an environment for the execution of at least some of the computer code involved in performing the disclosed methods, such as stress analysis module 700. In addition to block 700, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 700, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 621 and the other storage media discussed below. The program instructions, and associated data, are accessed by processor set 610 to control and direct performance of the disclosed methods. In computing environment 600, at least some of the instructions for performing the disclosed methods may be stored in block 700 in persistent storage 613.

Communication fabric 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 701.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 700 typically includes at least some of the computer code involved in performing the disclosed methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the disclosed methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601) and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 743 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A wind turbine comprising:
a plurality of turbine blades,
wherein each of the plurality of turbine blades includes a plurality of openings that extend through each of the plurality of turbine blades, the plurality of openings are adapted to be opened or closed, and at least one of the plurality of openings is adapted to be opened to allow air to flow therethrough.

2. The wind turbine of claim 1, wherein the plurality of openings each include a plurality of louvers that are capable of opening and closing the plurality of openings.

3. The wind turbine of claim 1, wherein the plurality of openings are capable of being partially closed.

4. The wind turbine of claim 1, wherein the plurality of openings are opened and closed using a sliding mechanism located in the plurality of turbine blades.

5. The wind turbine of claim 1, further comprising:
a control system with a control unit connected with at least one activating mechanism such that the control unit is adapted to activate the at least one activating mechanism and open or close the plurality of openings.

6. The wind turbine of claim 5, wherein the control system includes sensors on the wind turbine that are adapted to provide measurements to allow for activation of the at least one activating mechanism.

7. The wind turbine of claim 1, wherein the at least one of the plurality of openings is adapted to be opened to allow air to flow therethrough when the wind turbine nears or reaches a cut-out speed of the wind turbine.

8. A method comprising:
providing a wind turbine including a plurality of turbine blades, wherein each of the plurality of turbine blades includes a plurality of openings that extend through each of the plurality of turbine blades, the plurality of openings are adapted to be opened or closed, and the plurality of openings are adapted to be opened to allow air to flow through the plurality of turbine blades;
performing a stress analysis on the plurality of turbine blades using parameters of the wind turbine and a wind profile; and
controlling the plurality of openings to open one or more of the plurality of openings based on the stress analysis.

9. The method of claim 8, further comprising:
measuring a rotational speed of the wind turbine; and
opening at least one of the plurality of openings to allow air to flow therethrough when the rotational speed nears or reaches a cut-out speed of the wind turbine.

10. The method of claim 8, wherein the plurality of openings each include a plurality of louvers that are capable of opening and closing the plurality of openings.

11. The method of claim 8, wherein the plurality of openings are capable of being partially closed.

12. The method of claim 8, wherein the plurality of openings are opened and closed using a sliding mechanism located in the plurality of turbine blades.

13. The method of claim 8, wherein the controlling the plurality of openings is performed using a control system with a control unit connected with at least one activating mechanism such that the control unit activates the at least one activating mechanism to open or close the plurality of openings.

14. The method of claim 13, wherein the control system includes sensors on the wind turbine that are adapted to provide measurements to allow for activation of the at least one activating mechanism.

15. A system comprising.
a wind turbine comprising:
a plurality of turbine blades, wherein each of the plurality of turbine blades includes a plurality of openings that extend through each of the plurality of turbine blades, the plurality of openings are adapted to be opened or closed, and at least one of the plurality of openings is adapted to be opened to allow air to flow therethrough; and
a control system with a control unit connected with at least one activating mechanism such that the control unit activates the at least one activating mechanism to open or close the plurality of openings.

16. The system of claim 15, wherein the control system includes sensors on the wind turbine that are adapted to provide measurements to allow for activation of the at least one activating mechanism.

17. The system of claim 15, further comprising:
a stress analyzer for analyzing stress on the plurality of turbine blades.

18. The system of claim 17, wherein the stress analyzer analyzes parameters of the wind turbine and a wind profile.

19. The system of claim 17, wherein the control system controls the plurality of openings based on the stress analysis of the stress analyzer.

20. The system of claim 15, wherein the plurality of openings each include a plurality of louvers that are capable of opening and closing the plurality of openings.
